(19) United States
(12) Patent Application Publication
(10) Pub. No.: US 2009/0154086 A1
(43) Pub. Date: Jun. 18, 2009

(54) Casing structure and electronic device

(75) Inventors: Masaki Ishikawa, Kawasaki (JP); Naoki Miyakoshi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/285,786

(22) Filed: Oct. 14, 2008

(30) Foreign Application Priority Data
Dec. 14, 2007 (JP) 2007-323430

(51) Int. Cl. G06F 1/16

(52) U.S. Cl. 361/679.22

(57) ABSTRACT

The casing structure includes a first frame having a top surface section; a second frame having a top surface section and a bent section that is bent on the top surface section at a location where the the second frame abuts the first frame; and a hinge mounted over the top surface section of the first frame including the location and the top surface section of the second part. The hinge secures an LCD to the second frame.

### BACKGROUND OF THE INVENTION

1. Field of the Invention

The present invention relates to a casing structure for an electronic device, such as a personal computer, and an electronic device having the casing structure as a frame.

2. Description of Related Art

In recent years, a display-integrated personal computer gains popularity among desktop personal computers in which a display has been integrated with a main body of the computer.

FIG. 8 is a perspective view of an exemplary display-integrated personal computer.

A liquid crystal display (LCD) integrated personal computer 20 that has a liquid crystal display 22 is shown in FIG. 8, as an example of such a display-integrated personal computer. The LCD-integrated personal computer 20 includes a main body section 21 having a CPU (Central Processing Unit), a memory, and a hard disk; the LCD 22 connected to the main body section 21 to be rotatable with a hinge in the direction of an arrow D shown in FIG. 8; and a keyboard 23 for entering a user's indication or text information to the LCD-integrated personal computer 20. The keyboard 23 may be a wireless keyboard 23 that wirelessly transmits information entered by a user to the main body section 21. In addition, the main body section 21 may further include a drive that may read and write data from/to CD (Compact Disc) or DVD (Digital Versatile Disc). The front surface of the drive is covered with a lid 24 that is openable and closable. The drive will be detailed later.

The LCD 22 itself acts as a load to the main body section 21 of the LCD-integrated personal computer 20. Therefore, when the LCD 22 rotates by a user, the LCD 22 is pressed against the main body section 21 with the load and a force applied by the user.

FIG. 9 is a view illustrating a state where the LCD is pressed to the main body section when the LCD rotates.

The LCD-integrated personal computer 20 has a space for receiving the keyboard 23 shown in FIG. 8 under the main body section 21. When the main body section 21 is subjected to the weight of the LCD 22 itself or force applied by the user in the direction (F) of an arrow in FIG. 9, the main body section 21 may be bent toward the space for receiving the keyboard 23 as shown in dotted lines of FIG. 9. Such bending of the main body section 21 may disfigure the product, or for example, deteriorate assembling accuracy in a case where such bending takes place by a test LCD 22 during assembling.

Accordingly, this LCD-integrated personal computer requires a reinforced casing structure for the main body section which may endure the force as shown in FIG. 9.

A general desktop-type personal computer also requires consideration of forces applied to its main body section since a CRT (Cathode Ray Tube) display may be placed on the main body section, and in this sense, an reinforced casing structure has been proposed for the main body section. For instance, Japanese Patent Application Publication No. 2002-91618 proposes a reinforced casing structure which is reinforced by forming a concave and convex structure using a draw-bending process, and Japanese Patent Application Publication No. 2006-92456 proposes a casing structure on which a frame is additionally mounted that has a rib structure.

In the field of LCD-integrated personal computers, recently, the load exerted onto the casing structure tends to increase correspondingly as liquid crystal displays become larger and larger. In the conventional casing structures, for example, disclosed in the above patent publications, whenever the load applied onto the casing structure increases, the casing structure needs to be fundamentally redesigned. Accordingly, it becomes difficult to apply the casing structure to LCD-integrated personal computers to which increased load is expected to be applied. Thus, a casing structure is required which is sufficient in strength and easy to be further reinforced.

Although the LCD-integrated personal computer has been exemplified to describe any problems associated with reinforcement of casing structures, these problems are not limited to such an LCD-integrated personal computer. These problems may generally exist in display-integrated personal computers having the other display than the liquid crystal display, and furthermore in any electronic devices on which something heavy such as display is placed.

### SUMMARY OF THE INVENTION

The present invention has been made in view of the above circumstances and provides a casing structure that is not only sufficient in strength but also easy to be further reinforced, and an electronic device having the casing structure as a frame.

A casing structure according to an aspect of the present invention includes:

a first part having a top surface section;

a second part having a top surface section and a bending section that is bent on the top surface section at a position where the first part and the second part abut each other; and

a securing part mounted on the top surface section of the first part, which includes the position, and the top surface section of the second part, the securing part securing a predetermined part to an upper portion of the second part.

According to the aspect of the casing structure, a load, such as the weight of the predetermine part or force exerted onto the part, is applied onto an interface between the first part and the second part through the securing part. At this time, the second part has the bending section at the location of abutting the first part. The bending section has high strength against the load, and therefore, the basic example of the casing structure may exhibit sufficient reinforcement against the load. The casing structure has two parts, and therefore, if the casing structure needs to be further reinforced in the future, the casing structure may be easily reinforced further by making the first part have a bending section at the location of abutting the second part without changing the fundmental principle of the present invention that the casing structure has the two parts. That is, the casing structure according to the aspect may exhibit sufficient strength and easily provide further reinforcement.

It is preferable, in the casing structure according to the present invention, that the top surface section of the first part has a concave section depressed from a base surface of the top surface section.

With this preferable feature, the concave section, which improves the strength of the first part, cooperates with the bending section of the second part to enable further reinforced casing structure.

Further preferably, in the casing structure according to the present invention, the first part has a bottom surface section facing the top surface section, and the bottom surface section has a convex section protruding from a base surface of the bottom surface section to an upper side of the base surface.

With this preferable feature, the convex section, which improves the strength of the first part, cooperates with the bending section of the second part to enable further reinforced casing structure.

In addition, according to the present invention, the top surface section of the second part may have a surface which becomes broader as further goes in a longitudinal direction, and

the second part further has:

a surface which becomes broader as further goes in a lateral direction of the top surface section, which is a direction crossing the longitudinal direction;

a hole or a depressed section formed in the position where the first part and the second part abut each other; and

a beam part that is selectively mounted at the second part, passes through the hole or depressed section of the second part, and extends in the longitudinal direction of the top surface section.

With this preferable feature, the casing structure may be reinforced by attaching the beam part to the second part, and this allows easier reinforcement of the casing structure.

Further preferably, according to the present invention, the second part has a leg section that is disposed on the first part, extended downward from the first part and supports the top surface section, and the first part has a leg section that is in surface contact with the leg section of the second part.

With this preferable feature, there may be provided a casing structure having high-strength leg section that includes the leg section of the first part overlaps the leg section of the second part.

In addition, the first part may have a bending section that abuts the bending section of the second part.

With this preferable feature, the bending section of the first part also exhibits high strength against a load such as the weight of the predetermined part or force exerted onto the part, and the bending section of the first part cooperates with the bending section of the second part to enable further reinforced casing structure.

Further preferably, the second part has a bottom surface section connected to a surface extending downward from the bending section, and a receiving section that detachably receives an input device at a lower portion of the bottom surface section.

With this preferable feature, there may be provided the casing structure that is reinforced by the bending section of the second part as well as provided with the receiving section.

Further preferably, the leg section of the second part may be provided at both ends in the longitudinal direction of the top surface section of the second part.

With this preferable feature, the top surface section of the second part may be integrally formed with the leg section of the second part by a simple process, for example, bending process.

According to another aspect of the present invention, in an electronic device having the above casing structure as a frame, the predetermined part performs a main function of the electronic device.

With this feature, the frame of the electronic device is sufficient in strength and easy to be further reinforced.

Further, it is preferable that the electronic device has a machine-driving electronic part creating vibration; and an attachment part attached to a predetermined location of the machine-driving electronic part through a gasket, the attachment part mounting the machine-driving electronic part in the receiving section of the second part.

With this feature, the gasket may absorb vibration created, for example, by a machine-driving electronic part such as a drive for DVD mounted in a personal computer.

In addition, the predetermined part may include a display unit.

With this feature, there may be provided an electronic device having the frame, such as a display-integrated personal computer in which the display unit has been integrated with the main body section of the personal computer.

Further preferably, the second part has a predetermined opening, the first part has an opening provided at a location facing the opening of the second part, and the opening of the first part and the opening of the second part constitute a receiving section for an electronic part.

With this feature, there may be provided an electronic device having the frame that has a receiving section for the electronic part.

As described above, the casing structure, which has been sufficiently reinforced, may be further reinforced according to the casing structure and the electronic device of the present invention. Specific effects of the exemplary embodiment of the present invention are as follows:

1. Sufficient strength may be previously ensured according to the present invention, and therefore, even when the display is exchanged with a heavier one, the existing frame mold may be reused,

2. The number of designing steps may be considerably decreased by 1),

3. Considerable reduction in cost may be expected by 1), and

4. It is possible to permit maximum inhibition of increase in size compared to conventional reinforcing means, and this makes a product compact or highly densified.

### BRIEF DESCRIPTION OF THE DRAWINGS

FIG. 1 is a perspective view illustrating an LCD-integrated personal computer that is an embodiment of an electronic device according to the present invention.

FIG. 2 is a view illustrating the LCD-integrated personal computer shown in FIG. 1, where an LCD and its outer plate have been removed from the LCD-integrated personal computer to expose a frame.

FIG. 3 is a perspective view illustrating a first frame.

FIG. 4 is a perspective view illustrating an interface between the first frame and a second frame, as seen in the direction of an arrow B shown in FIG. 2.

FIG. 5 is a perspective view illustrating a rear surface of the frame shown in FIG. 2, where a drive is mounted.

FIG. 6 is a perspective view illustrating the drive held by two securing parts at both sides of the drive.

FIG. 7 is a perspective view illustrating a securing part.

FIG. 8 is a perspective view of an exemplary LCD-integrated personal computer.

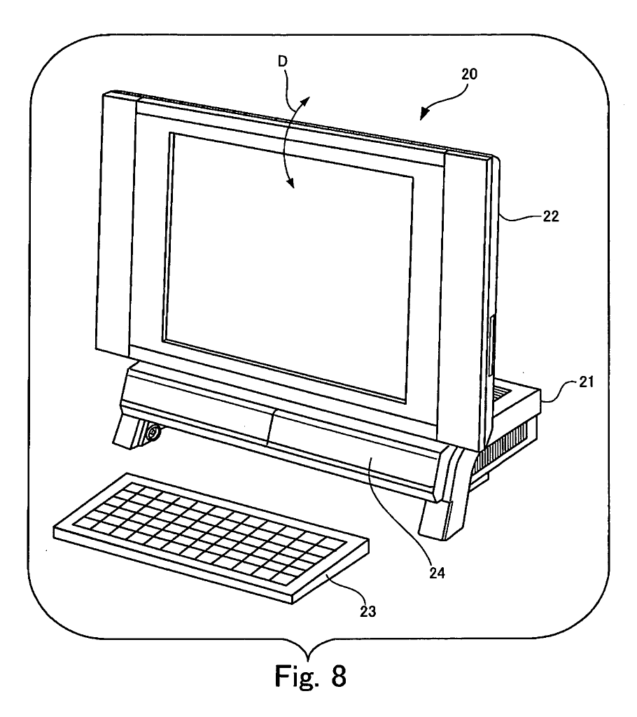

FIG. 9 is a view illustrating a state where the LCD shown in FIG. 8 is pressed to the main body section when the LCD rotates.

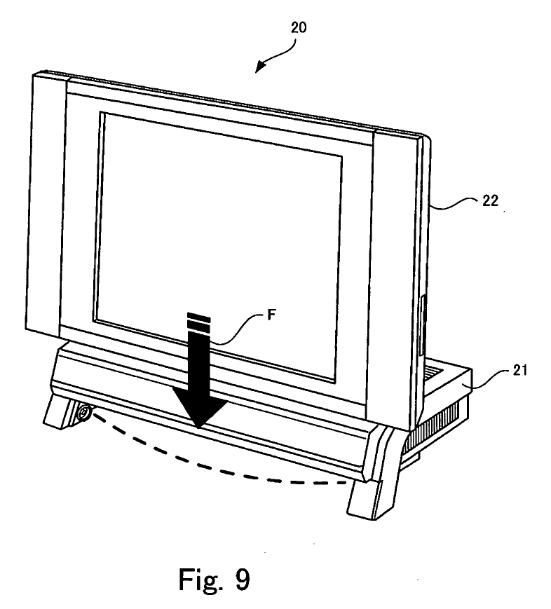

### DETAILED DESCRIPTION OF THE INVENTION

Embodiments of a casing structure and an electronic device having the casing structure will be described more specifically with reference to accompanying drawings.

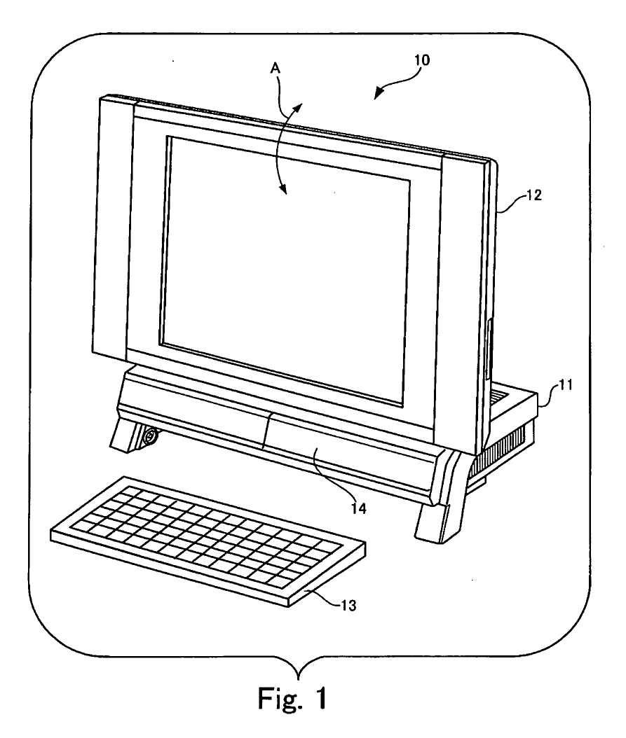

FIG. 1 is a perspective view illustrating an LCD-integrated personal computer that is an embodiment of an electronic device according to the present invention.

Referring to FIG. 1, the LCD-integrated personal computer 10 includes a main body section 11 having a CPU (Central Processing Unit), a memory, and a hard disk; a liquid crystal display 12 connected to the main body section 11 to be rotatable with a hinge in the direction of an arrow A shown in FIG. 1; and a keyboard 13 for entering a user's indication or text information to the LCD-integrated personal computer 10. The keyboard 13 may be a wireless keyboard that wirelessly transmits information entered by a user to the main body section 11. The hinge will be described later. In this embodiment, the keyboard 13 enters a receiving space provided under the main body section 11. A drive to be described later is mounted in the main body section 11, which may read and write data from/to a CD or DVD, and covered with a lid 14 for drive that may open and close the front surface of the main body section 11. The LCD 12 corresponds to an example of the display unit in the electronic device according to the present invention.

Hereinafter, the descriptions will focus on the structure of the frame included in the LCD-integrated personal computer 10.

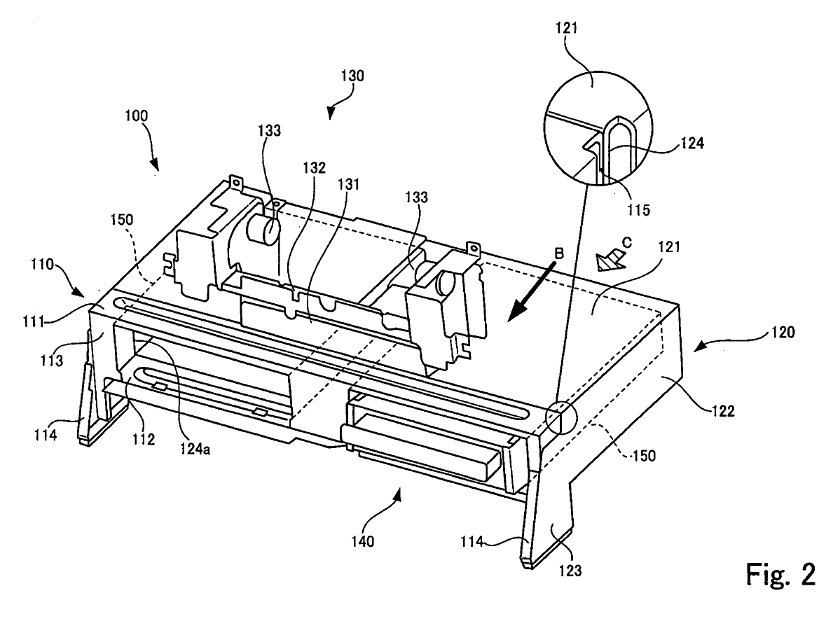

FIG. 2 is a view illustrating the LCD-integrated personal computer 10 shown in FIG. 1, where the LCD 12 and its outer plate have been removed from the LCD-integrated personal computer 10 to expose a frame.

Referring to FIG. 2, a frame 100 is shown, which is included in the LCD-integrated personal computer 10 shown in FIG. 1. The frame 100 includes a first frame 110 and a second frame 120 constituting the main body section 11; and a hinge 130 by which the LCD 12 is joined to the second frame 120 so as to be freely rotated. FIG. 2 depicts a state where the lid 14 for drive shown in FIG. 1 has been removed from the drive 140 mounted in the frame 100. The drive 140 corresponds to an example of the machine-driving electronic part in the electronic device according to the present invention.

Here, the frame 100 shown in FIG. 2 corresponds to an example of the casing structure according to the present invention. And, the first frame 110, the second frame 120, and the hinge 130 correspond to an example of the first part, the second part, and the securing part, respectively, in the casing structure according to the present invention.

The first frame 110 includes a top surface section 111 which is a wall of the LCD 12 side shown in FIG. 1; a bottom surface section 112 located opposite to the top surface section 111; a front surface section 113 connecting the top surface section 111 to the bottom surface section 112; and two leg sections 114 that are provided at both left side and right side of the first frame 110. Here, the top surface section 111 corresponds to an example of the top surface section of the first part in the casing structure, the bottom surface section 112 corresponds to an example of the bottom surface section of the first part the casing structure according to the present invention, and the leg section 114 corresponds to an example of the leg section of the first part in the casing structure according to the present invention.

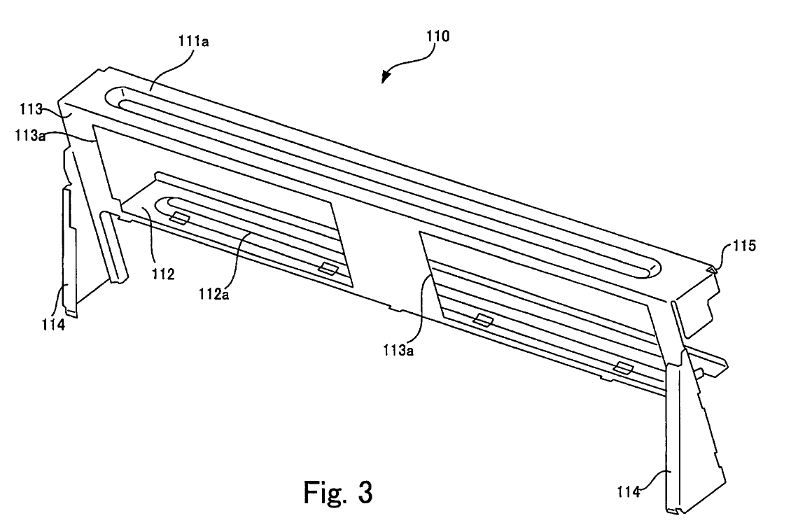

FIG. 3 is a perspective external view illustrating a first frame according to an exemplary embodiment of the present invention.

Referring to FIG. 3, the top surface section 111 of the first frame 110 has a concave section 111a that is formed by a draw-bending process to be recessed in the direction facing the bottom surface section 112 and to be extended in the longitudinal direction. The bottom surface section 112 has a convex section 112a also formed by the draw-bending process to be protruded toward the top surface section 111 and extended in the longitudinal direction. And, the front surface section 113 has two openings 113a through which the drive 140 shown in FIG. 2 is inserted when the drive 140 is mounted in the frame 100. In this exemplary embodiment, the first frame 110 has a bending section 115 that is formed by being bent at an edge of the top surface section 111 opposite to the edge of the front surface section 113. Here, the concave section 111a corresponds to an example of the concave section of the first part in the casing structure, the convex section 112a corresponds to an example of the convex section of the first part, the opening 113a corresponds to an example of the opening of the first part, and the bending section 115 corresponds to an example of the bending section of the first part in the casing structure according to the present invention.

The first frame 110 has been detailed with reference to FIG. 3. A structure of the frame included in the LCD-integrated personal computer 10 will now be described with reference to FIG. 2.

Returning to FIG. 2, the second frame 120 includes a top surface section 121 which is a wall of the LCD 12 side shown in FIG. 1; two side surface sections 122 that are extended from the top surface section 121 and provided at both left side and right side of the second frame 120; and two plate-shaped leg sections 123, each of which extends from the left and right side surface sections 122, respectively, toward the first frame 110. In this exemplary embodiment, the leg section 123 of the second frame 120 is in surface-contact with the leg section 114 of the first frame 110. As shown in enlarged view of FIG. 2, the second frame 120 further includes a front surface section 124 formed by bending an edge of the first frame 110 from the top surface section 121. In this exemplary embodiment, the front surface section 124 is in surface-contact with the bending section 115 of the first frame 110. Here, the top surface section 121 corresponds to an exemplary top surface section of the second part in the basic example of the casing structure described above, the leg section 114 corresponds to an exemplary leg section of the second part in an application example of the casing structure described above, and the front surface section 124 corresponds to an exemplary bending section of the second part in the basic example of the casing structure described above.

In the second frame 120, the front surface section 124 has two openings 124a through which the drive 140 shown in FIG. 2 is inserted when the drive 140 is mounted in the second frame 120. In this exemplary embodiment, the two openings 124a of the second frame 120 face the two openings 113a of the first frame 110, respectively. Two receiving sections 150 are constituted, each of which is defined by the opening 113a of the first frame 110, the opening 124a of the second frame 120, and a predetermined space provided in the second frame 120. The drive 140 is received in the receiving section 150. The drive 140 is received in only one of the two receiving sections 150, i.e. right receiving section, as shown in FIG. 2. Here, the opening 124a of the second frame 120 corresponds to an exemplary opening of the second part in an application example of the casing structure described above, and the receiving section 150 corresponds to an exemplary electronic part receiving section in an application example of the casing structure described above.

The hinge 130 includes a base section 131 secured to the top surface section 121 of the second frame by screws; an arm section 132 secured by screws to a metal frame (not shown) that constitutes the LCD 12 shown in FIG. 1; and a rotational axis 133 securing the arm section 132 to the base section 131 so that the arm section 132 is free to rotate.

Here, in the frame 100, the base section 131 is secured near the front surface section 124 in the top surface section 121 of the second frame, and a portion of the base section 131 is placed near the bending section 115 in the top surface section 111 of the first frame 110. Accordingly, a load, such as the weight of the LCD 12 or hinge 130 and a force pressing the LCD 12 onto the main body section 11 which is produced when the LCD 12 is rotated by users, is exerted onto an interface between the first frame 110 and the second frame 120 through the hinge 130. At this time, the front surface section 124 of the second frame 120 is existent near the interface, which is formed by a bending process. The front surface section 124 of the second frame 120 has a great strength agaist a load applied from the front surface section 121 of the second frame 120, and therefore, the interface also has a great strength against the load exerted through the hinge 130. In this exemplary embodiment, the bending section 115 of the first frame 110 is also existent near the interface, which is formed by a bending process. The bending section 115 of the first frame 110 has a great strength against a load applied from the top surface section 111 of the first frame 110, and therefore, the interface also has a great strength against the load exerted through the hinge 130. In this exemplary embodiment, the first frame 110 is reinforced by the concave section 111a recessed in the top surface section 111 of the first frame 110 and the convex section 112a protruding from the bottom surface section 112a of the first frame 110. The interface may be further reinforced by reinforcement of the first frame 110.

As such, the frame 100 according to the exemplary embodiment of the present invention has been formed as a reinforced casing structure that has sufficient strength against the load involved in the LCD 12, thus effectively preventing bending of the LCD-integrated personal computer 10 caused by such load.

In the frame 100 according to the exemplary embodiment of the present invention, the leg section 123 of the second frame 120 is in surface-contact with the leg section 114 of the first frame 110 as described above. As a result, the frame 100 may have high-strength leg sections that consist of two types of leg sections 123 and 114.

In the field of LCD-integrated personal computers, recently, the load exerted onto the frame tends to increase correspondingly as liquid crystal displays become larger and larger. In the frame 100 according to the exemplary embodiment of the present invention, it is contrived to further reinforce the interface in preparation for a case where larger LCD is mounted on the frame 100.

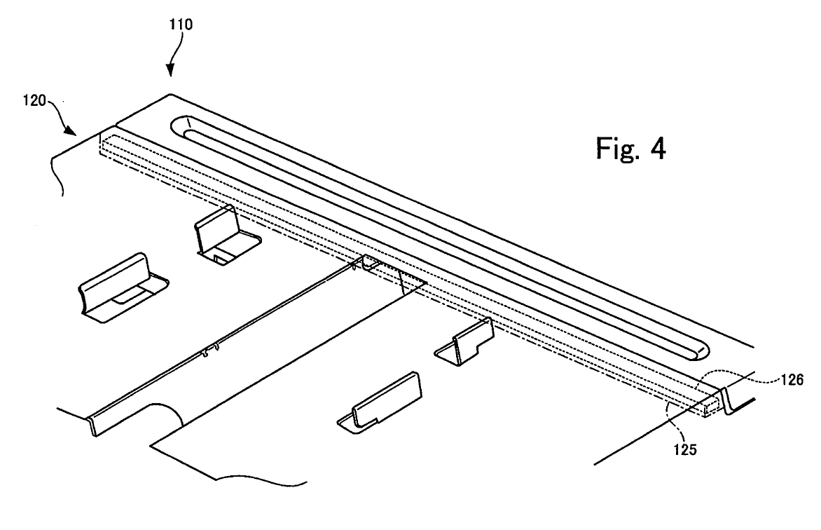

FIG. 4 is a perspective view illustrating an interface between the first frame and the second frame as seen in the direction of an arrow B shown in FIG. 2. The hinge 130 has been omitted from FIG. 4 for easy viewing.

In this exemplary embodiment, a hole 125 is formed in the second frame 120, which is extended along the interface. And in this exemplary embodiment, an additional reinforcing member, i.e. beam part 126, as represented in dotted limes in FIG. 4, may be adapted to be suitably inserted into the hole 125 as necessary. Accordingly, although the load exerted onto the interface increases through the hinge 130 due to mounting of larger LCD onto the frame, the interface may be further reinforced by inserting the beam part 126 in the hole 125. Here, the hole 125 corresponds to an exemplary hole of the second part of the casing structure according to the invention, and the beam part 126 corresponds to an exemplary beam part of the casing structure according to the present invention.

In this exemplary embodiment, mounting of the drive 140 in the frame 100 shown in FIG. 2 has also been contrived. Hereinafter, the mounting of the drive 140 will be described.

In this exemplary embodiment, the mounting of the drive 140 is performed from the rear side of the frame 100 as marked with an arrow C shown in FIG. 2.

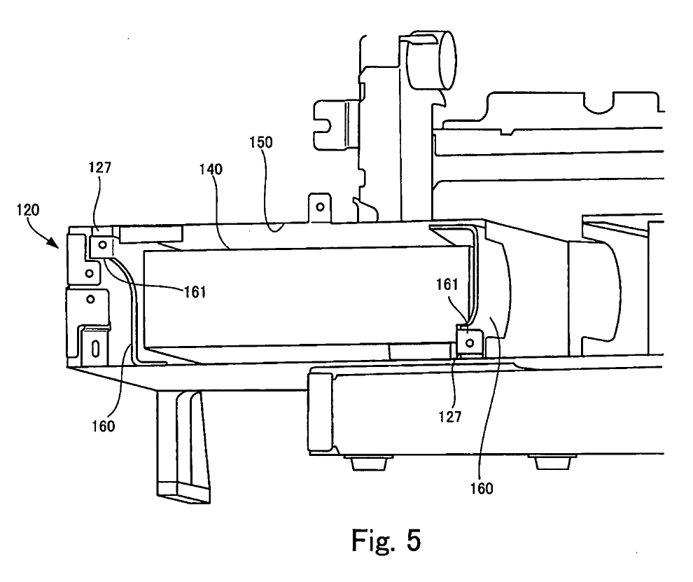

FIG. 5 is a perspective view illustrating a rear surface of the frame shown in FIG. 2, where a drive has been mounted.

As shown in FIG. 5, the drive 140 enters the receiving section 150 shown in the FIG. 2, such that the drive 140 is interposed between two attachment parts 160 arranged at both sides of the drive 140. The attachment parts 160 will be described later in detail. The attachment part 160 includes a flange 161 that has a through-hole. If the drive 140 is received in the receiving section 150, the flange 161 is brought in contact with an attachment section 127 provided at the rear surface of the second frame 120, which has a threaded bore. And, an attachment screw (not shown) passes through the through-hole of the flange 161 and is inserted into the threaded bore of the attachment section 127, so that the received drive 140 is secured to the second frame 120. Here, the attachment part 160 corresponds to an exemplary attachment part in the electronic device according to the present invention.

Hereinafter, the attachment part 160 will be described more specifically.

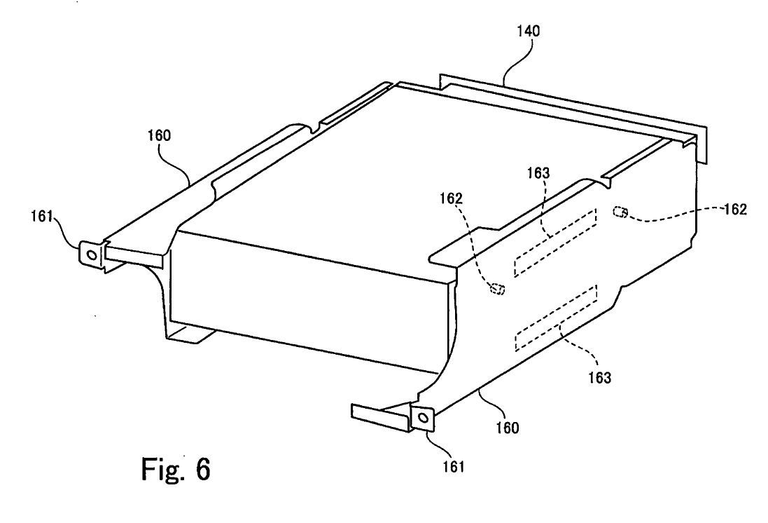

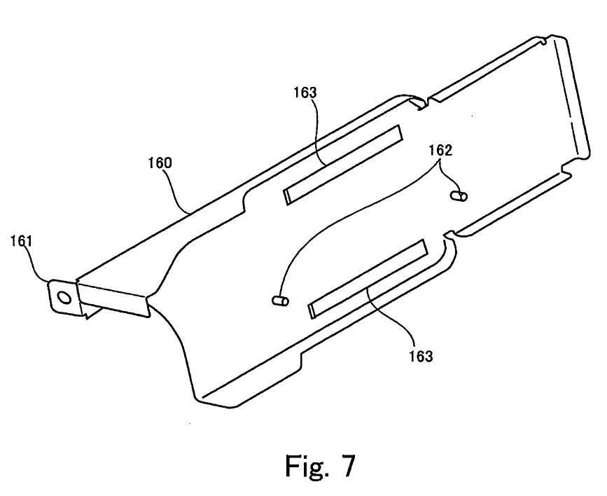

FIG. 6 is a perspective view illustrating a drive held by two securing parts at both sides of the drive, and FIG. 7 is a perspective view illustrating a securing part according to an exemplary embodiment of the present invention.

Referring to FIG. 6, the drive 140 is inserted into between the two attachment parts 160 which are identical to each other. Here, since the attachment parts 160 are shaped asymmetrically from each other, if the flange 161 of the attachment part 160 abutting one side of the drive 140 is positioned near the top side of the drive 140, the flange 161 of the attachment part 16Q abutting the other side of the drive 140 is positioned near the bottom side of the drive 140. Accordingly, each attachment section 127 of the second frame 120 shown in FIG. 5 is configured to correspond to the location of each flange 161 of the attachment part 160, with the drive 140 inserted between the attachment parts 160.

Two pins 162 protrude from a surface of the attachment part 160 facing a side surface of the drive 140 as indicated by dotted lines of FIG. 6 and solid lines of FIG. 7. The drive 140 has two holes at each side surface, through which the two pins are inserted when the drive 140 is inserted between the two attachment parts 160. Here, each attachment part 160 is secured to the drive 140 by the insertion of the pin 162 in the hole.

Two resilient gaskets 163 are provided at a surface of the attachment part 160 facing a side surface of the drive 140 as indicated by dotted lines of FIG. 6 and solid lines of FIG. 7. Accordingly, the drive 140 is inserted between the two attachment parts 160 through the gasket 163. Here, the drive 140 vibrates upon operation due to rotation of an inner motor (not shown). In this exemplary embodiment, the gasket 163 permits good absorption of such vibration of the drive 140, thus making it possible to inhibit noises produced while the LCD-integrated personal computer 10 operates.

As described above, the frame 100 of the LCD-integrated personal computer 10 according to the exemplary embodiments of the present invention may exhibit sufficient strength against loads applied to the LCD 12. In a case where an LCD larger than the LCD 12 is mounted on the frame and the load applied to the frame 100 increases, the frame 100 may be further reinforced by a simple method, such as attaching the beam part 126 to the frame 100. In the LCD-integrated personal computer 10 according to the exemplary embodiment, the drive 140 that reads and writes data from/to a CD or DVD is mounted in the frame 100 through the resilient gasket 163 by the two attachment parts 160 that hold the drive 140 at left and right sides. Accordingly, vibration occurring upon operation of the drive 140 may be well absorbed by the gasket 163, and therefore, noises created in the LCD-integrated personal computer 10 may be inhibited.

Although the LCD-integrated personal computer has been exemplified as an embodiment of the electronic device according to the present invention, the electronic device is not limited thereto. For instance, the electronic device may include a display-integrated personal computer having a display other than the LCD, or a common electronic device such as home appliances on which something heavy may be mounted, such as a display.

Although a method has been described in the exemplary embodiment, where the casing structure is further reinforced by adding a separate reinforcing member, i.e. a beam part, to the frame, the method of further reinforcing the casing structure is not limited thereto. For example, the casing structure may be further reinforced by making the bending section of the first frame 110 further higher.

What is claimed is:

1. A casing structure comprising:
a first part having a top surface section;
a second part having a top surface section and a bending section that is bent on the top surface section at a position where the first part and the second part abut each other; and
a securing part mounted on the top surface section of the first part, which includes the position, and the top surface section of the second part, the securing part securing a predetermined part to an upper portion of the second part.

2. The casing structure according to claim 1, wherein the top surface section of the first part has a concave section depressed from a base surface of the top surface section.

3. The casing structure according to claim 1, wherein the first part has a bottom surface section facing the top surface section, and
the bottom surface section has a convex section protruding from a base surface of the bottom surface section to an upper side of the base surface.

4. The casing structure according to claim 1, wherein the top surface section of the second part has a surface which becomes broader as further goes in a longitudinal direction, and
the second part further comprises:
a surface which becomes broader as further goes in a lateral direction of the top surface section, which is a direction crossing the longitudinal direction;
a hole or a depressed section formed in the position where the first part and the second part abut each other; and
a beam part that is selectively mounted on the second part, passes through the hole or depressed section of the second part, and extends in the longitudinal direction of the top surface section.

5. The casing structure according to claim 1, wherein the second part has a leg section that is disposed on the first part, extended downward from the first part and supports the top surface section, and
the first part has a leg section that is in surface contact with the leg section of the second part.

6. The casing structure according to claim 1, wherein the first part has a bending section that abuts the bending section of the second part.

7. The casing structure according to claim 1, wherein the second part has a bottom surface section connected to a surface extending downward from the bending section, and
a receiving section that removably contains an input device at a lower portion of the bottom surface section.

8. The casing structure according to claim 5, wherein the leg section of the second part is provided at both ends in the longitudinal direction of the top surface section of the second part.

9. An electronic device having a casing structure as a frame, wherein the casing structure comprises:
a first part having a top surface section;
a second part having a top surface section and a bending section that is bent on the top surface section at a position where the first part and the second part abut each other; and
a securing part mounted on the top surface section of the first part, which includes the position, and the top surface section of the second part, the securing part securing a predetermined part to an upper portion of the second part, and
the predetermined part performs a main function of the electronic device.

10. The electronic device according to claim 9, wherein the top surface section of the first part has a concave section depressed from a base surface of the top surface section.

11. The electronic device according to claim 9, wherein the first part has a bottom surface section facing the top surface section, and
the bottom surface section has a convex section protruding from a base surface of the bottom surface section to an upper side of the base surface.

12. The electronic device according to claim 9, wherein the top surface section of the second part has a surface which becomes broader as further goes in a longitudinal direction, and
the second part further comprises:
a surface which becomes broader as further goes in a lateral direction of the top surface section, which is a direction crossing the longitudinal direction;
a hole or a depressed section formed in the position where the first part and the second part abut each other; and
a beam part that is selectively mounted on the second part, passes through the hole or depressed section of the second part, and extends in the longitudinal direction of the top surface section.

13. The electronic device according to claim 9, wherein the second part has a leg section that is disposed on the first part, extended downward from the first part and supports the top surface section, and
the first part has a leg section that is in surface contact with the leg section of the second part.

14. The electronic device according to claim 9, wherein the first part has a bending section that abuts the bending section of the second part.

15. The electronic device according to claim 9, wherein the second part has a bottom surface section connected to a surface extending downward from the bending section, and
a receiving section that removably contains an input device at a lower portion of the bottom surface section.

16. The electronic device according to claim 9, wherein the leg section of the second part is provided at both ends in the longitudinal direction of the top surface section of the second part.

17. The electronic device according to claim 9, further comprising:
a machine-driving electronic part creating vibration; and
an attachment part attached to a predetermined location of the machine-driving electronic part through a gasket, the attachment part mounting the machine-driving electronic part in the receiving section of the second part.

18. The electronic device according to claim 9, wherein the predetermined part includes a display unit.

19. The electronic device according to claim 9, wherein the second part has a predetermined opening,
the first part has an opening provided at a location facing the opening of the second part, and
the opening of the first part and the opening of the second part constitute a receiving section for an electronic part.
